(19) United States
(12) Patent Application Publication
(10) Pub. No.: US 2026/0179844 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Jung Tae PARK, Suwon-si (KR); Sung Hyung KANG, Suwon-si (KR); Yong Il KWON, Suwon-si (KR); Sang Yeop KIM, Suwon-si (KR)

(73) Assignee: SAMSUNG ELECTRO-MECHANICS CO., LTD., Suwon-si (KR)

(21) Appl. No.: 19/402,229

(22) Filed: Nov. 26, 2025

(30) Foreign Application Priority Data
Dec. 24, 2024 (KR) 10-2024-0196022

(51) Int. Cl. H01G 4/224; H01G 4/005; H01G 4/232; H01G 4/248; H01G 4/30; H01G 13/00

(52) U.S. Cl. CPC H01G 4/224; H01G 4/005; H01G 4/232; H01G 4/248; H01G 4/30; H01G 13/003; H01G 13/006

(57) ABSTRACT

A multilayer electronic component includes a body including a dielectric layer and an internal electrode alternately disposed with the dielectric layer in a first direction, a first side margin portion and a second side margin portion respectively disposed on a fifth surface and a sixth surface of the body, and a first external electrode and a second external electrode respectively disposed on a third surface and a fourth surface of the body. An upper portion in the first direction of each of the first and second side margin portions has an asymmetric shape with respect to a lower portion in the first direction of each of the first and second side margin portions, and a width in a third direction of the upper portion in the first direction of each of the first and second side margin portions increases as a distance from the second surface increases.

### CROSS-REFERENCE TO RELATED APPLICATION(S)

This application claims benefit of priority to Korean Patent Application No. 10-2024-0196022 filed on Dec. 24, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

An MLCC may be used as a component of various electronic devices due to having a small size, ensuring high capacitance and being easily mounted. With the miniaturization and high-output power of various electronic devices such as computers and mobile devices, demand for miniaturization and implementation of high capacitance of multilayer ceramic capacitors has also been increasing.

In order to achieve miniaturization and high capacitance of an MLCC, it may be necessary to maximize an effective area of internal electrodes. To this end, in order to maximize the area in the width direction of the internal electrodes and suppress a step portion in the width direction caused by the internal electrodes, a method has been applied in which a side margin portion sheet is additionally attached to both surfaces in a width direction of a unit laminated bar to which an internal electrode pattern is exposed, and then sintering is performed.

However, in the method of additionally attaching the side margin portion sheet, a process may be complicated, and the side margin portion sheet and the unit laminated bar may be significantly affected by heat and pressure, thereby causing issues such as poor adhesion between the side margin portion sheet and the unit laminated bar and deformation, which may result in a decrease in reliability of a final product.

Accordingly, there is a need to develop a multilayer electronic component having a novel structure, which may simplify complexity of a process according to the related art and improve reliability of the multilayer electronic component.

### SUMMARY

An aspect of the present disclosure is to provide a multilayer electronic component having excellent reliability.

Another aspect of the present disclosure is to simplify a manufacturing process of a multilayer electronic component including side margin portions.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and internal electrodes alternately disposed with the dielectric layer in a first direction, the body having a first surface and a second surface opposing each other in the first direction, a third surface and a fourth surface connected to the first surface and the second surface, the third surface and the fourth surface opposing each other in a second direction, and a fifth surface and a sixth surface connected to the first to fourth surfaces, the fifth surface and the sixth surface opposing each other in a third direction, a first side margin portion and a second side margin portion disposed on the fifth surface and the sixth surface, respectively, and a first external electrode and a second external electrode disposed on the third surface and the fourth surface, respectively. A first portion in the first direction of each of the first and second side margin portions may have an asymmetric shape with respect to a second portion in the first direction of each of the first and second side margin portions, and a width, in the third direction, of the first portion of each of the first and second side margin portions may increase as a distance from the second surface increases.

According to another aspect of the present disclosure, there is provided a method of manufacturing a multilayer electronic component, the method including laminating a plurality of ceramic green sheets on which an internal electrode pattern is printed on at least one ceramic green sheet in a first direction to obtain a laminated bar, forming a gap in the laminated bar in a second direction that is perpendicular to the first direction, filling the gap with a slurry for side margin portion formation, cutting the laminated bar filled with the side margin portion slurry in the second direction and a third direction that is perpendicular to the first and second directions to obtain a plurality of unit laminated bars, sintering the plurality of unit laminated bars to obtain, for each sintered unit laminated bar, a body and a side margin portion disposed on both surfaces in the third direction of the body, and forming an external electrode on the body.

According to example embodiments of the present disclosure, a multilayer electronic component may have excellent reliability.

According to example embodiments of the present disclosure, a manufacturing process of a multilayer electronic component including side margin portions may be simplified.

However, the various advantages and effects of the present disclosure are not limited to those set forth herein, and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a perspective view of FIG. 1 from which an external electrode is excluded;

FIG. 3 is a perspective view of FIG. 2 from which a side margin portion is excluded;

FIG. 4 is a schematic cross-sectional view taken along line I-I′ of FIG. 1;

FIG. 5 is a schematic cross-sectional view taken along line II-II′ of FIG. 1;

FIG. 6 is a schematic perspective view of an operation of obtaining a laminated bar;

FIG. 7 illustrates a laminated bar before a gap is formed;

FIG. 8 illustrates a state in which a gap is being formed in a laminated bar;

FIG. 9 illustrates a laminated bar after a gap is formed;

FIG. 10 is a front view of a state in which a gap of a laminated bar is filled with a side margin portion slurry; and

FIG. 11 is a perspective view of a state in which a gap of a laminated bar is filled with a side margin portion slurry.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction may be defined as a lamination direction or a thickness (T) direction, a second direction may be defined as a length (L) direction, and a third direction may be defined as a width (W) direction.

### Multilayer Electronic Component

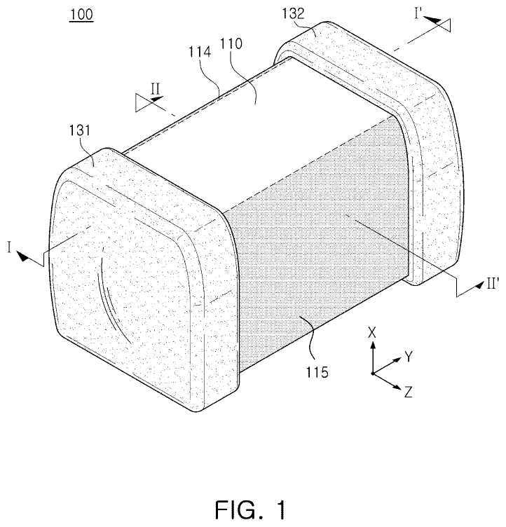

FIG. 1 is a schematic perspective view of a multilayer electronic component according to an example embodiment of the present disclosure.

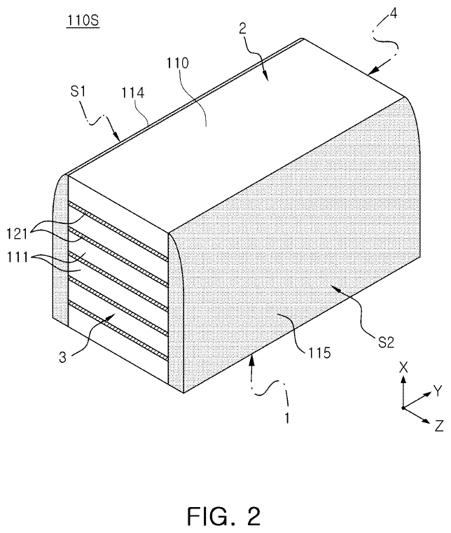

FIG. 2 is a perspective view of FIG. 1 from which an external electrode is excluded.

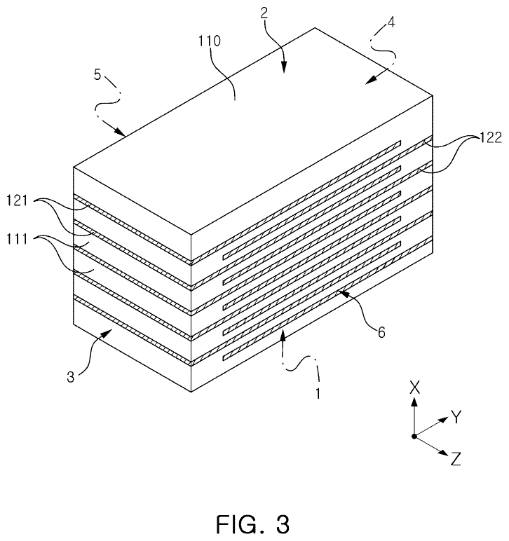

FIG. 3 is a perspective view of FIG. 2 from which a side margin portion is excluded.

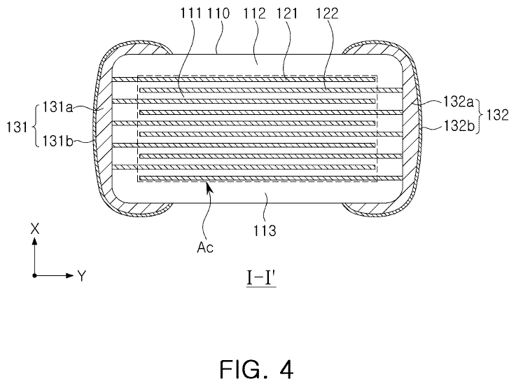

FIG. 4 is a schematic cross-sectional view taken along line I-I′ of FIG. 1.

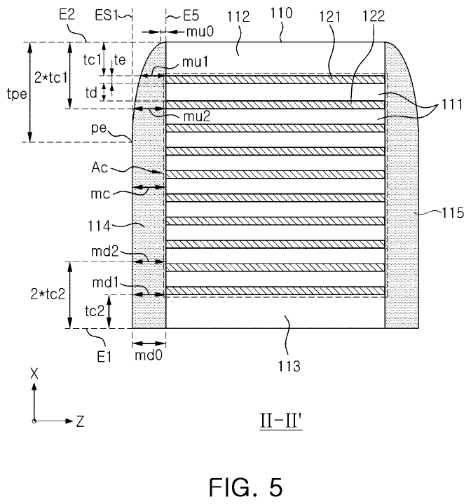

FIG. 5 is a schematic cross-sectional view taken along line II-II′ of FIG. 1.

Hereinafter, a multilayer electronic component 100 according to an example embodiment of the present disclosure will be described in detail with reference to FIGS. 1 to 5. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

A multilayer electronic component 100 according to an example embodiment of the present disclosure may include a body 110 including a dielectric layer 111 and internal electrodes 121 and 122 alternately laminated with the dielectric layer in a first direction, the body having a first surface 1 and a second surface 2 opposing each other in the first direction, a third surface 3 and a fourth surface 4 connected to the first and second surfaces, the third surface and the fourth surface opposing each other in a second direction, and a fifth surface 5 and a sixth surface 6 connected to the first to fourth surfaces, the fifth surface and the sixth surface opposing each other in a third direction; a first side margin portion 114 and a second side margin portion 115 respectively disposed on the fifth surface and the sixth surface; and a first external electrode 131 and a second external electrode 132 respectively disposed on the third surface and the fourth surface. An upper portion in a first direction of each of the first and second side margin portions may have an asymmetric shape with respect to a lower portion in the first direction of each of the first and second side margin portions. A width in the third direction of the upper portion in the first direction of each of the first and second side margin portions may increase as a distance from the second surface increases.

Hereinafter, each of components included in the multilayer electronic component 100 according to an example embodiment of the present disclosure will be described.

In the body 110, the dielectric layer 111 and the internal electrodes 121 and 122 may be alternately laminated.

A specific shape of the body 110 is not limited. However, as illustrated, the body 110 may have a hexahedral shape or a shape similar thereto. During a sintering process, ceramic powder particles, included in the body 110, may shrink, such that the body 110 may not have a hexahedral shape having perfectly straight lines.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in the second direction, and fifth and sixth surfaces 5 and 6 connected to the third and fourth surfaces 3 and 4, the fifth and sixth surfaces 5 and 6 opposing each other in the third direction.

A plurality of dielectric layers 111, included in the body 110, may be in a sintered state, and adjacent dielectric layers 111 may be integrated with each other such that boundaries therebetween are not readily apparent without using a scanning electron microscope (SEM). The number of laminated dielectric layers is not limited, and may be determined in consideration of a size of the multilayer electronic component. For example, the body may be formed by laminating 400 or more dielectric layers.

The dielectric layer 111 may be formed by preparing a ceramic slurry including ceramic powder particles, an organic solvent, and a binder, coating the slurry on a carrier film and drying the same to prepare a ceramic green sheet, and then sintering the ceramic green sheet. The ceramic powder particles are not limited as long as sufficient capacitance is obtainable therewith, and may be, for example, barium titanate-based (BaTiO₃)-based powder particles. As a more specific example, the barium titanate-based (BaTiO₃)-based powder particles may be at least one of BaTiO₃, (Ba₁₋ₓCaₓ)TiO₃ (0<x<1), Ba(Ti_{1-y}Ca_{y})O3 (0<y<1), (Ba₁₋ₓCaₓ) (Ti_{1-y}Zr_{y})O₃ (0<x<1, 0<y<1), and Ba(Ti_{1-y}Zr_{y})O₃ (0<y<1), and CaZrO₃-based paraelectric powder particles may be (Ca₁₋ₓSrₓ) (Zr_{1-y}Ti_{y})O₃ (0<x<1, 0<y<1).

Accordingly, the dielectric layer 111 may include at least one of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and (Ca₁₋ₓSrₓ)(Zr_{1-y}Ti_{y})O₃ (0<x<1, 0<y<1).

The body 110 may include a capacitance formation portion Ac disposed in the body 110, the capacitance formation portion Ac having capacitance by including the first internal electrode 121 and the second internal electrode 122 disposed to oppose each other with the dielectric layer 111 interposed therebetween, and cover portions 112 and 113 disposed on upper and lower portions in the first direction of the capacitance formation portion Ac.

In addition, the capacitance formation portion Ac may be a portion contributing to forming capacitance of a capacitor, and may be formed by repeatedly laminating a plurality of first and second internal electrodes 121 and 122 on each other with the dielectric layer 111 interposed therebetween.

The cover portions 112 and 113 may be disposed on both surfaces in the first direction of the capacity formation portion Ac.

The cover portions 112 and 113 may include a first cover portion 112 disposed on the upper portion in the first direction of the capacitance formation portion Ac, and a second cover portion 113 disposed on the lower portion in the first direction of the capacitance formation portion Ac. The first cover portion 112 may be referred to as an upper cover portion, and the second cover portion 113 may be referred to as a lower cover portion.

The first cover portion 112 and the second cover portion 113 may be respectively formed by laminating one dielectric layer or two or more dielectric layers on upper and lower surfaces of the capacitance formation portion Ac in a thickness direction, and may basically serve to prevent the internal electrode from being damaged due to physical or chemical stress.

The first cover portion 112 and the second cover portion 113 may not include the internal electrode, and may include a material the same as that of the dielectric layer 111.

That is, the first cover portion 112 and the second cover portion 113 may include a ceramic material, and may include, for example, a barium titanate (BaTiO₃)-based ceramic material.

A thickness of each of the cover portions 112 and 113 is not limited. However, in order to easily achieve miniaturization and high capacitance of the multilayer electronic component, each of a thickness (tc1) of the first cover portion 112 and a thickness (tc2) of the second cover portion 113 may be 20 μm or less.

The thickness (tc1) of the first cover portion 112 and the thickness (tc2) of the second cover portion 113 may be equal to each other, but the present disclosure is not limited thereto, and the thickness (tc1) of the first cover portion 112 and the thickness (tc2) of the second cover portion 113 may have different values.

The thickness (tc1) of the first cover portion 112 may refer to a size in the first direction, and may be an average of sizes in the first direction of the first cover portion 112, measured at five points spaced apart from each other at equal intervals in the third direction. The thickness (tc2) of the second cover portion 113 may be measured in the same manner.

The side margin portions 114 and 115 may be disposed on the fifth and sixth surfaces of the body 110.

The side margin portions 114 and 115 may include a first side margin portion 114 disposed on the fifth surface and a second side margin portion 115 disposed on the sixth surface.

The first side margin portion 114 may be disposed on one surfaces in the third direction of the capacitance formation portion Ac and the cover portions 112 and 113, and the second side margin portion 115 may be disposed on the other surfaces in the third direction of the capacitance formation portion Ac and the cover portions 112 and 113.

The side margin portions 114 and 115 may basically serve to prevent the internal electrode from being damaged due to physical or chemical stress.

The upper portion in the first direction of each of the first and second side margin portions 114 and 115 may have an asymmetric shape with respect to the lower portion in the first direction of each of the first and second side margin portions 114 and 115.

The width in the third direction of the upper portion in the first direction of each of the first and second side margin portions 114 and 115 may increase as a distance from second surface increases. Accordingly, stress applied to the multilayer electronic component may be relieved, and an area of a lower surface in the first direction of the multilayer electronic component may be larger than an area of an upper surface in the first direction of the multilayer electronic component, thereby improving mounting reliability when mounted on a substrate. In addition, the multilayer electronic component may have improved reliability, and a manufacturing process of the multilayer electronic component including the side margin portions may be simplified.

Referring to FIG. 5, in an example embodiment, the body 110 may include a capacitance formation portion Ac including internal electrodes 121 and 122, and first and second cover portions 112 and 113 respectively disposed on an upper portion and a lower portion in the first direction of the capacitance formation portion. When a width in the third direction of the first side margin portion 114, measured on the second surface, is referred to as mu0, a width in the third direction of the first side margin portion 114, measured at a boundary between the first cover portion 112 and the capacitance formation portion, is referred to as mu1, and a width in the third direction of the first side margin portion 114, measured at a point spaced apart from the second surface in the first direction by twice a thickness (tc1) of the first cover portion, is referred to as mu2, mu0<mu1<mu2 may be satisfied.

In an example embodiment, mu0<2*mu2 may be satisfied. In addition, mu0 may converge to 0.

In an example embodiment, a width in the third direction of a lower portion in the first direction of each of the first and second side margin portions 114 and 115 has a deviation of 10% or less.

In addition, the lower portion in the first direction of each of the first and second side margin portions 114 and 115 may have a substantially uniform width in the third direction.

In an example embodiment, when a width in the third direction of the first side margin portion, measured on the first surface, is referred to as md0, a width in the third direction of the first side margin portion, measured at a boundary between the second cover portion and the capacitance formation portion, is referred to as md1, and a width in the third direction of the first side margin portion, measured at a point spaced apart from the first surface in the first direction by twice a thickness of the second cover portion, is referred to as md2, a deviation between md0, md1, and md2 may be 10% or less.

In an example embodiment, when a width in the third direction of the first side margin portion, measured on the second surface, is referred to as mu0, a width in the third direction of the first side margin portion, measured on the first surface, is referred to as md0, and a width in the third direction of the first side margin portion, measured at a center in the first direction of the body is referred to as mc, 0.9≤md0/mc≤1.1 and mu0/mc≤0.5 may be satisfied.

In an example embodiment, when a width in the third direction of the first side margin portion, measured on the second surface, is referred to as mu0, and a width in the third direction of the first side margin portion, measured at a center in the first direction of the body, is referred to as mc, mu0/mc≤0.1 may be satisfied.

In an example embodiment, the body may include a capacitance formation portion including the internal electrode, and first and second cover portions respectively disposed on an upper portion and a lower portion in the first direction of the capacitance formation portion. When a thickness in the first direction of the upper cover portion is referred to as tc1, an outer peripheral surface in the third direction of the first side margin portion, parallel to a fifth surface, is referred to as an S1 surface, a point in an upper portion in the first direction of the first side margin portion at which an extension line of the S1 surface starts is referred to as pe, and a thickness in the first direction from an extension line of the second surface to pe are referred to tpe, tc1<tpe may be satisfied.

In this case, 2*tc1<tpe may be satisfied.

The internal electrodes 121 and 122 may include first and second internal electrodes 121 and 122. The first and second internal electrodes 121 and 122 may be alternately disposed to oppose each other with the dielectric layer 111, included in the body 110, interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body and connected to the first internal electrode 121, and a second external electrode 132 may be disposed on the fourth surface 4 of the body and connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance.

In an example embodiment, the internal electrodes 121 and 122 may include a first internal electrode 121 led out to the third, fifth, and sixth surfaces, and a second internal electrode 122 led out to the fourth, fifth, and sixth surfaces. Both ends in the third direction of each of first and second internal electrodes 121 and 122 may be in contact with the side margin portions 114 and 115.

A conductive metal, included in the internal electrodes 121 and 122, may include at least one of Ni, Cu, Pd, Ag, Au, Pt, In, Sn, Al, Ti, and alloys thereof, but the present disclosure is not limited thereto.

An average thickness (td) of dielectric layer 111 is not limited, but may be, for example, 0.1 μm to 10 μm. An average thickness (te) of each of the internal electrodes 121 and 122 is not limited, but may be, for example, 0.05 μm to 3.0 μm. In addition, the average thickness (td) of the dielectric layer 111 and the average thickness (te) of each of the internal electrodes 121 and 122 may be arbitrarily set depending on desired characteristics or usage. For example, in order to achieve miniaturization and high capacitance, in the case of a small IT electronic component, the average thickness (td) of the dielectric layer 111 may be 0.45 μm or less, and the average thickness (te) of each of the internal electrodes 121 and 122 may be 0.45 μm or less.

The average thickness (td) of the dielectric layer 111 and the average thickness (te) of each of the internal electrodes 121 and 122 may respectively refer to a size in the first direction of the dielectric layer 111, and a size in the first direction of each of the internal electrodes 121 and 122. The average thickness (td) of the dielectric layer 111 and the average size (te) of each of the internal electrodes 121 and 122 may be measured, for example, by scanning, with an SEM, a cross-section in the first and second directions of the body 110 at a magnification of 10,000. More specifically, the average thickness (td) of the dielectric layer 111 may be measured by measuring thicknesses of one dielectric layer 111 at multiple points of the dielectric layer 111, for example, thirty points spaced apart from each other at equal intervals in the second direction, and calculating an average value of the thicknesses. In addition, the average thickness (te) of each of the internal electrodes 121 and 122 may be measured by measuring thicknesses of each of the internal electrodes 121 and 122 at multiple points, for example, thirty points spaced apart from each other at equal intervals in the second direction, and calculating an average value of the thicknesses. The thirty points, spaced apart from each other at equal intervals, may be designated in the capacitance formation portion Ac. In addition, when such average value measurement is performed on ten dielectric layers 111 and ten internal electrodes 121 and 122, the average thickness (td) of the dielectric layer 111 and the average thickness (te) of each of the internal electrodes 121 and 122 may be further generalized.

The widths (e.g., mu0, mu1, mu2, md0, md1, md2, and mc) and thicknesses (e.g., tc1 and tpe) disclosed herein may be measured with an SEM. Other methods and/or tools appreciated by one of ordinary skill in the art, even if not described in the present disclosure, may also be used.

The external electrodes 131 and 132 may be disposed on the third and fourth surfaces 3 and 4 of the body 110, respectively.

The external electrodes 131 and 132 may be disposed on the third and fourth surfaces 3 and 4 of the body 110, respectively, and may include first and second external electrodes 131 and 132 respectively connected to the first and second internal electrodes 121 and 122.

Referring to FIG. 1, the external electrodes 131 and 132 may be disposed to cover both end surfaces in the second direction of the side margin portions 114 and 115.

In the present example embodiment, a structure in which the multilayer electronic component 100 has two external electrodes 131 and 132 is described, but the number and shape of the external electrodes 131 and 132 may be changed depending on the form of the internal electrodes 121 and 122 or other purposes.

Each of the external electrodes 131 and 132 may be formed of any material having electrical conductivity, such as a metal or the like, and a specific material may be determined in consideration of electrical characteristics, structural stability, or the like. In addition, each of the external electrodes 131 and 132 may have a multilayer structure.

For example, the external electrodes 131 and 132 may include electrode layers 131a and 132a disposed on the body 110, and plating layers 131b and 132b formed on the electrode layers.

As a more specific example of the electrode layers 131a and 132a, the electrode layers may be a sintered electrode including a conductive metal and glass, or a resin-based electrode including a conductive metal and resin.

In addition, the electrode layers 131a and 132a may have a form in which a sintered electrode and a resin-based electrode are sequentially formed on the body 110. In addition, the electrode layers 131a and 132a may be formed by transferring a sheet including a conductive metal onto the body 110 or by transferring a sheet including a conductive metal onto the sintered electrode.

A material having excellent electrical conductivity may be used as the conductive metal included in the electrode layers 131a and 132a, but the material is not limited. For example, the conductive metal may be at least one of nickel (Ni), copper (Cu), and an alloy thereof.

The plating layers 131b and 132b may serve to improve mounting characteristics. A type of each of the plating layers 131b and 132b is not limited, and each of the plating layers 131b and 132b may be a plating layer including at least one of Ni, Sn, Pd, and alloys thereof, and may be formed as a plurality of layers.

As a more specific example of the plating layers 131b and 132b, each of the plating layers 131b and 132b may be a Ni plating layer or a Sn plating layer, may have a form in which a Ni plating layer and a Sn plating layer are sequentially formed on the electrode layers 131a and 132a, and may have a form in which a Sn plating layer, a Ni plating layer, and a Sn plating layer are sequentially formed. In addition, each of the plating layers 131b and 132b may include a plurality of Ni plating layers and/or a plurality of Sn plating layers.

A size of the multilayer electronic component 100 is not limited.

However, in order to achieve miniaturization and high capacitance of multilayer electronic component 100, the multilayer electronic component 100 may have a size of 0603 (length: 0.6 mm, width: 0.3 mm) or more. In consideration of a manufacturing error or the like, a maximum length in the second direction (L) of the body 110 may be 0.69 mm or less, and a maximum width in the third direction (W) of the body 110 may be 0.39 mm or less.

Here, the maximum length in the second direction (L) of the body 110 may refer to a maximum size in the second direction of the body 110, the maximum width in the third direction (W) of the body 110 may refer to a maximum size in the third direction of the body 110, and a maximum thickness in the first direction (T) of the body 110 may refer to a maximum size in the first direction of the body 110.

### Method of Manufacturing Multilayer Electronic Component

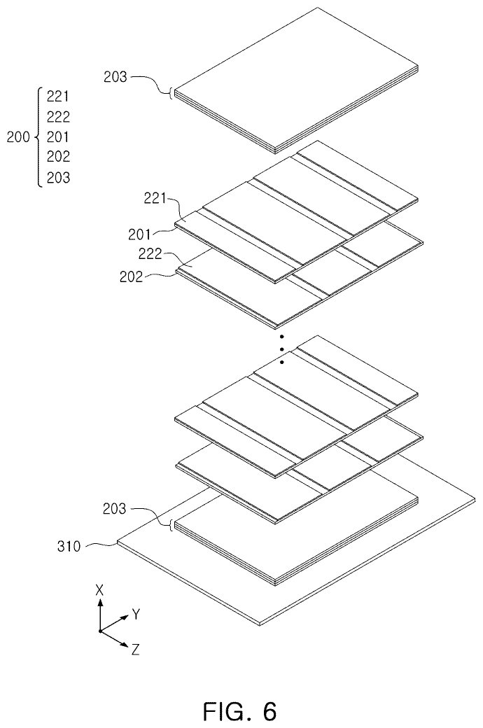

FIG. 6 is a schematic perspective view of an operation of obtaining a laminated bar.

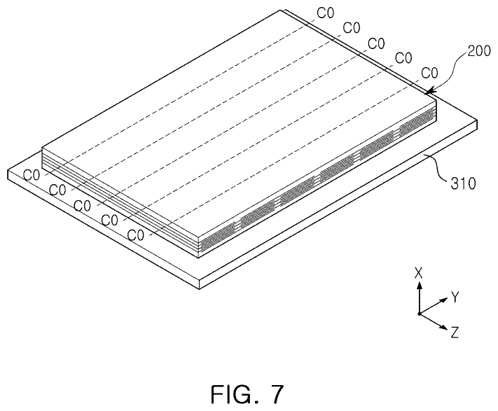

FIG. 7 illustrates a laminated bar before a gap is formed.

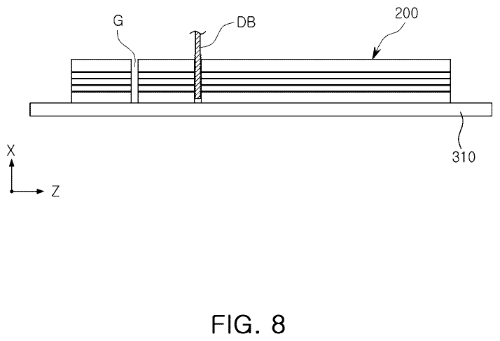

FIG. 8 illustrates a state in which a gap is being formed in a laminated bar.

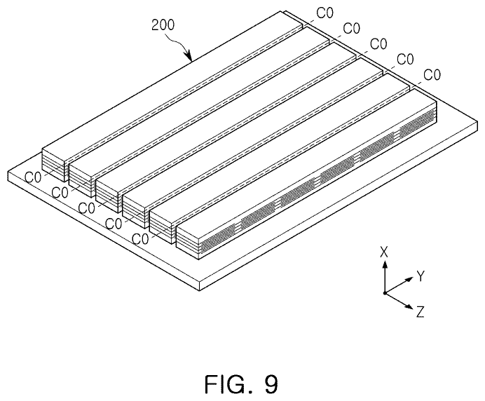

FIG. 9 illustrates a laminated bar after a gap is formed.

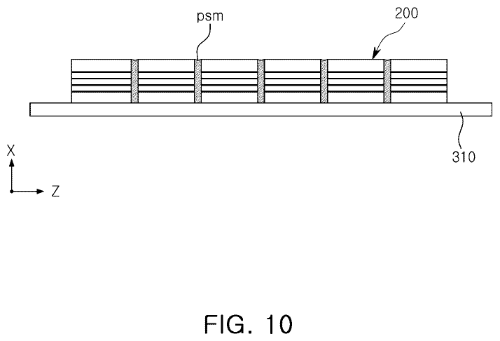

FIG. 10 is a front view of a state in which a gap of a laminated bar is filled with a side margin portion slurry.

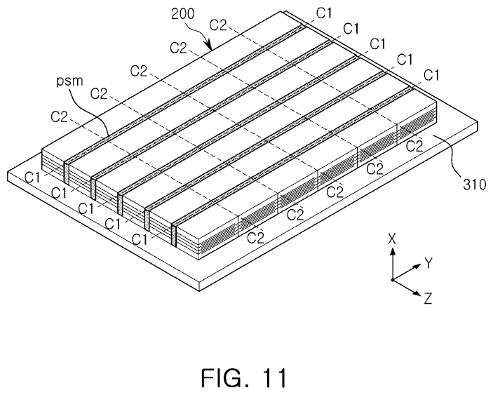

FIG. 11 is a perspective view of a state in which a gap of a laminated bar is filled with a side margin portion slurry.

Hereinafter, a method of manufacturing a multilayer electronic component will be described in detail with reference to FIGS. 6 to 11. The method of manufacturing a multilayer electronic component described below is an example of manufacturing the above-described multilayer electronic component 100, and it may not be necessary to manufacture the multilayer electronic component 100 only by the manufacturing method described below.

A method of manufacturing a multilayer electronic component according to an example embodiment of the present disclosure may include obtaining a laminated bar 200 by laminating ceramic green sheets 201 and 202 on which internal electrode patterns 221 and 222 are printed in a first direction; forming a gap G in the laminated bar 200 in a second direction, perpendicular to the first direction, filling the gap with a slurry for side margin portion formation psm, obtaining a plurality of unit laminated bars by cutting the laminated bar 200 filled with the slurry for side margin portion formation psm in the second direction and in a third direction, perpendicular to the first and second directions, obtaining a body 110 and side margin portions 114 and 115 disposed on both surfaces in the third direction of the body by sintering the unit laminated bars, and forming external electrodes 131 and 132 on the body.

### Manufacturing of Laminated Bar

First, a laminated bar 200 may be obtained by laminating ceramic green sheets 201 and 202 on which internal electrode patterns 221 and 222 are printed in a first direction. At least a portion of the laminated bar 200 may be a portion included in a body 110 of the present disclosure after sintering.

In an operation of manufacturing the laminated bar 200, a plurality of ceramic green sheets 201 and 202 on which the internal electrode patterns 221 and 222 are disposed may be laminated on a support film 310.

The support film 310 may serve to support the laminated bar 200 in which the internal electrode patterns 221 and 222 and the plurality of ceramic green sheets 201 and 202 are stacked. In this case, the support film 310 may include an adhesive material such as latex, starch, cellulose, protein, isoprene rubber (IR), nitrile butadiene rubber (NBR), styrene butadiene rubber (SBR), chloroprene rubber (CR), silicon rubber, silicon-based material, urethane-based material, acryl-based material, and mixtures thereof.

The plurality of ceramic green sheets 201 and 202 may be formed of a ceramic paste including ceramic powder particles, an organic solvent, a dispersing agent, and a binder. The ceramic powder particles may include a barium titanate-based material, a lead composite perovskite-based material, or a strontium titanate-based material as a raw material included in a dielectric layer 111 of the multilayer electronic component 100. The barium titanate-based material may include BaTiO₃-based ceramic powder particles. Examples of the ceramic powder may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) obtained by partially dissolving Ca or Zr in BaTiO₃. When the plurality of ceramic green sheets 201 and 202 are sintered, the sintered ceramic green sheets 201 and 202 may become the dielectric layer 111 included in the body 110.

In an example embodiment, the laminated bar 200 may further include a cover portion ceramic green sheet 203 included in the cover portions 112 and 113. The ceramic green sheet for a cover portion 203 may be formed of a material and element the same as those of the ceramic green sheets 201 and 202, but the present disclosure is not limited thereto. Through a sintering process, the first and second cover portions 112 and 113 of the body 110 may be formed. In this case, the cover portion ceramic green sheet 203 may be formed on one surface and the other surface in the first direction of the laminated bar, and may be formed of a single layer or a plurality of layers.

The internal electrode patterns 221 and 222 may be formed on the ceramic green sheets 201 and 202 using an internal electrode paste including a conductive metal. The conductive metal included in the internal electrode patterns 221 and 222 is not limited, and a material having excellent electrical conductivity may be used. For example, the conductive metal may include at least one of nickel (Ni), copper (Cu), palladium (Pd), silver (Ag), gold (Au), platinum (Pt), tin (Sn), tungsten (W), titanium (Ti), and alloys thereof. A method of forming the internal electrode patterns 221 and 222 on the ceramic green sheets 201 and 202 is not limited. For example, the internal electrode patterns 221 and 222 may be formed by printing the internal electrode conductive paste including the conductive metal on the ceramic green sheets 201 and 202 using a screen-printing method or gravure printing method.

The internal electrode patterns 221 and 222 may have a stripe shape. Specifically, the internal electrode pattern may be formed to be in contact with both ends in the third direction of each of the ceramic green sheets 201 and 202 at regular intervals in the second direction.

The internal electrode patterns 221 and 222 may include a first internal electrode pattern 221 formed on the ceramic green sheet 201, and a second internal electrode pattern 222 formed on another ceramic green sheet 202.

In an example embodiment, the ceramic green sheet on which the internal electrode pattern is printed may include a first ceramic green sheet 201 on which the first internal electrode pattern 221 is printed, and a second ceramic green sheet 202 on which the second internal electrode pattern 222 is printed. The laminated bar 200 may be formed by alternately laminating the first and second ceramic green sheets 201 and 202 in the first direction, and a ceramic green sheet 203 on which no internal electrode pattern is printed may be laminated on an upper portion and a lower portion in the first direction of the laminated bar.

### Gap Forming Operation

A gap G may be formed in the laminated bar 200 in a second direction, perpendicular to the first direction.

Referring to FIGS. 7 and 8, the gap G may be formed in the laminated bar 200 along a gap formation line C0-C0. The gap formation line C0-C0 may be a cutting line, parallel to the second direction, and may be disposed at substantially equal intervals in the third direction.

A method of forming the gap G in the laminated bar 200 is not limited. For example, a dicing cutting method may be used, and cutting may be performed using a dicing blade DB having a width equal to a sum of a width in the third direction of a first side margin portion and a width in the third direction of a second side margin portion of a final product.

In this case, as the gap G is formed in the laminated bar 200, the internal electrode pattern may be exposed to a cut surface in which the gap G is formed.

In addition, the gap G may be formed to pass through the laminated bar 200 in the first direction.

### Operation of Filling Side Margin Portion Slurry

Subsequently, a slurry for side margin portion formation psm may be filled in the gap G of the laminated bar 200.

The slurry for side margin portion formation psm filled in the gap G may decrease in volume in a direction of a lower portion in the first direction of the side margin portion during drying, such that an upper portion in the first direction of the side margin portion may have a recessed shape. After sintering, the upper and lower portions in the first direction of the side margin portion may have an asymmetric shape with respect to each other.

The slurry for side margin portion formation psm may include ceramic powder particles, an organic solvent, a dispersant, and a binder. The ceramic powder particles included in the slurry for side margin portion formation psm may be the same as the ceramic powder particles included in the above-described ceramic green sheet, but the present disclosure is not limited thereto, and different ceramic powder particles may also be used. In addition, an additive included in the slurry for side margin portion formation psm may include a different element from that of an additive added to the ceramic green sheet, or may include the same element but in different contents.

In the related art, in order to form a side margin portion, a method has been applied in which a side margin portion sheet is additionally attached to both surfaces in a width direction of a unit laminated bar to which an internal electrode pattern is exposed, and then sintering is performed.

However, in the method of additionally attaching the side margin portion sheet, a process may be complicated, and the side margin portion sheet and the unit laminated bar may be significantly affected by heat and pressure, thereby causing issues such as poor adhesion between the side margin portion sheet and the unit laminated bar and deformation, which may result in a decrease in reliability of a final product.

According to an example embodiment of the present disclosure, after the gap G is formed in the laminated bar 200, the slurry for side margin portion formation psm may be filled in the gap G of the laminated bar 200, thereby not only reducing the influence of heat and pressure but also suppressing the occurrence of issues such as poor adhesion between the side margin portion sheet and the unit laminated bar and deformation. Accordingly, the multilayer electronic component 100 may have improved moisture resistance reliability.

### Operation of Obtaining Unit Laminated Bar

A plurality of unit laminated bars may be obtained by cutting the laminated bar 200 filled with the slurry for side margin portion formation psm in the second direction and a third direction, perpendicular to the first and second directions.

Referring to FIG. 11, the laminated bar 200 may be cut along cutting lines C1-C1 and C2-C2, perpendicular to each other. The cutting line C1-C1 may be a cutting line, parallel to the second direction, and may be disposed at substantially equal intervals in the third direction, and the cutting line C2-C2 may be a cutting line, parallel to the third direction, and may be disposed at substantially equal intervals in the second direction. A unit chip 210 having a substantially uniform size in the third direction may be formed by the cutting line C1-C1, and a unit laminated bar having a substantially uniform size in the second direction may be formed by the cutting line C2-C2.

The means for cutting the laminated bar 200 is not limited. For example, a blade cutting method, a guillotine cutting method, or a laser cutting method may be used to cut the laminated bar 200.

In an example embodiment, cutting in the second direction may be performed on a central portion in the third direction of a side margin portion paste filled in the gap. That is, the cutting line C1-C1 may be positioned on the side margin portion paste.

### Sintering Operation

Subsequently, the unit laminated bar may be sintered to obtain a body and a side margin portion disposed on both surfaces in the third direction of the body. A sintering temperature is not limited. However, for example, sintering may be performed at 1000 to 1300 [symbol] . In addition, sintering may be performed under a reducing atmosphere.

### Operation of Forming External Electrode

Subsequently, an external electrode may be formed on the body. The multilayer electronic component 100 may be manufactured by forming external electrodes 131 and 132 on one surface and the other surface in the second direction of the body 110, respectively.

For example, when base electrode layers 131a and 132a include a sintered electrode layer, the body 110 may be dipped into an external electrode conductive paste including metal powder particles, glass frit, a binder, and an organic solvent, and then the electrode conductive paste may be sintered at a temperature of 500° C. to 900° C. to form the sintered electrode layer.

For example, when the base electrode layers 131a and 132a include a resin electrode layer, the body may be dipped into a conductive resin composition including metal powder particles, resin, a binder, and an organic solvent, and then cured by heat treatment at a temperature of 250° C. to 550° C. to form the resin electrode layer.

In addition, the plating layers 131b and 132b may be formed on the base electrode layers 131a and 132a by further performing an electrolytic plating method and/or an electroless plating method.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are for the purpose of describing particular example embodiments only and are to not be limiting of the example embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer and internal electrodes alternately disposed with the dielectric layer in a first direction, the body having a first surface and a second surface opposing each other in the first direction, a third surface and a fourth surface connected to the first surface and the second surface, the third surface and the fourth surface opposing each other in a second direction, and a fifth surface and a sixth surface connected to the first to fourth surfaces, the fifth surface and the sixth surface opposing each other in a third direction;
a first side margin portion and a second side margin portion disposed on the fifth surface and the sixth surface, respectively; and
a first external electrode and a second external electrode disposed on the third surface and the fourth surface, respectively,
wherein a first portion in the first direction of each of the first and second side margin portions has an asymmetric shape with respect to a second portion in the first direction of each of the first and second side margin portions, and a width, in the third direction, of the first portion of each of the first and second side margin portions increases as a distance from the second surface increases.

2. The multilayer electronic component of claim 1, wherein
the body includes:
a capacitance formation portion including the internal electrodes, and
first and second cover portions disposed on a first portion of the capacitance formation portion and a second portion of the capacitance formation portion, respectively, in the first direction, and
the first side margin portion is disposed to cover first surfaces in the third direction of the capacitance formation portion and the first and second cover portions, and the second side margin portion is disposed to cover second surfaces in the third direction of the capacitance formation portion and the first and second cover portions.

3. The multilayer electronic component of claim 1, wherein
the body includes:
a capacitance formation portion including the internal electrodes, and
first and second cover portions disposed on a first portion of the capacitance formation portion and a second portion of the capacitance formation portion, respectively, in the first direction,
when a width, in the third direction, of the first side margin portion, measured on the second surface, is referred to as mu0, a width, in the third direction, of the first side margin portion, measured at a boundary between the first cover portion and the capacitance formation portion, is referred to as mu1, and a width, in the third direction, of the first side margin portion, measured at a point spaced apart from the second surface in the first direction by twice a thickness of the first cover portion, is referred to as mu2, mu0<mu1<mu2 is satisfied.

4. The multilayer electronic component of claim 3, wherein mu0<2 *mu2 is satisfied.

5. The multilayer electronic component of claim 1, wherein a width, in the third direction, of the second portion of each of the first and second side margin portions has a deviation of 10% or less.

6. The multilayer electronic component of claim 2, wherein, when a width, in the third direction, of the first side margin portion, measured on the first surface of the body, is referred to as md0, a width, in the third direction, of the first side margin portion, measured at a boundary between the second cover portion and the capacitance formation portion, is referred to as md1, and a width, in the third direction, of the first side margin portion, measured at a point spaced apart from the first surface of the body in the first direction by twice a thickness of the second cover portion, is referred to as md2, a deviation between md0, md1, and md2 is 10% or less.

7. The multilayer electronic component of claim 1, wherein, when a width, in the third direction, of the first side margin portion, measured on the second surface, is referred to as mu0, a width, in the third direction, of the first side margin portion, measured on the first surface, is referred to as md0, and a width, in the third direction, of the first side margin portion, measured at a center in the first direction of the body is referred to as mc, 0.9≤md0/mc≤1.1 and mu0/mc≤0.5 are satisfied.

8. The multilayer electronic component of claim 1, wherein, when a width, in the third direction, of the first side margin portion, measured on the second surface, is referred to as mu0, and a width in the third direction of the first side margin portion, measured at a center in the first direction of the body, is referred to as mc, mu0/mc≤0.1 is satisfied.

9. The multilayer electronic component of claim 1, wherein
the body includes:
a capacitance formation portion including the internal electrodes, and
first and second cover portions disposed on a first portion of the capacitance formation portion and a second portion of the capacitance formation portion, respectively, in the first direction,
when a thickness, in the first direction, of the first cover portion is referred to as tc1, an outer peripheral surface in the third direction of the first side margin portion, parallel to a fifth surface, is referred to as an S1 surface, a point in the first portion in the first direction of the first side margin portion at which an extension line of the S1 surface starts is referred to as pe, and a thickness in the first direction from an extension line of the second surface to pe is referred to tpe, tc1<tpe is satisfied.

10. The multilayer electronic component of claim 9, wherein 2*tc1<tpe is satisfied.

11. The multilayer electronic component of claim 1, wherein the internal electrodes include a first internal electrode led out to the third, fifth, and sixth surfaces, and a second internal electrode led out to the fourth, fifth, and sixth surfaces.

12. A method of manufacturing a multilayer electronic component, the method comprising:
laminating a plurality of ceramic green sheets on which an internal electrode pattern is printed on at least one ceramic green sheet in a first direction to obtain a laminated bar;
forming a gap in the laminated bar in a second direction that is perpendicular to the first direction;
filling the gap with a side margin portion slurry;
cutting the laminated bar filled with the side margin portion slurry in the second direction and a third direction that is perpendicular to the first and second directions to obtain a plurality of unit laminated bars;
sintering the plurality of unit laminated bars to obtain, for each sintered unit laminated bar, a body and a side margin portion disposed on both surfaces in the third direction of the body; and
forming an external electrode on the body.

13. The method of claim 12, wherein the forming of the gap is performed such that the internal electrode pattern is exposed to a cut surface in which the gap is formed.

14. The method of claim 12, wherein the gap is formed to pass through the laminated bar in the first direction.

15. The method of claim 12, wherein in the cutting of the laminated bar, cutting in the second direction is performed on a central portion, in the third direction, of the side margin portion slurry in the gap.

16. The method of claim 12, wherein
the at least one ceramic green sheet on which the internal electrode pattern is printed includes a first ceramic green sheet on which a first internal electrode pattern is printed, and a second ceramic green sheet on which a second internal electrode pattern is printed, and
the laminated bar is formed by alternately laminating the first and second ceramic green sheets in the first direction, and ceramic green sheets on which no internal electrode pattern is printed are laminated on a first portion and a second portion of the laminated bar in the first direction.
